(19) United States
(12) Patent Application Publication
(10) Pub. No.: US 2008/0005946 A1
(43) Pub. Date: Jan. 10, 2008

(54) Display formed of multiple fragmented images

(76) Inventor: Beverly E. Gary, Mineral, VA (US)

Correspondence Address: LITMAN LAW OFFICES, LTD., P.O. BOX 15035, CRYSTAL CITY STATION, ARLINGTON, VA, 22215, US

(21) Appl. No.: 10/998,995

(22) Filed: Nov. 30, 2004

(51) Int. Cl. G09F 19/00

(52) U.S. Cl. 40/615

(57) ABSTRACT

The display formed of multiple fragmented images is formed by folding at least one translucent sheet and placing a first image fragment on the sheet to one side of the fold line. A second image fragment is placed on the sheet to the opposite side of the fold line from the first image fragment. The sheet is then folded with the two sides or leaves of the sheet overlying one another to place the two image fragments in registry with one another, allowing the image to be viewed in its entirety. The second image fragment may be applied in mirror image to the first image fragment on the same surface of the sheet, or may alternatively be applied to the opposite surface of the sheet in proper orientation. Multiple sheets may be used with more than two images applied to form more complex fragmented patterns, and the bottom leaf may be opaque.

### BACKGROUND OF THE INVENTION

1. Field of the Invention

The present invention relates generally to two-dimensional images and displays formed on multiple sheets. More specifically, the present invention comprises a display device having two or more leaves with no more than one opaque leaf, in which each of the leaves has a fragmented message, image, or display thereon. Folding the leaves together into registry results in the image or display fragments aligning in registry with one another to permit the entire display to be seen or message to be read.

2. Description of the Related Art

Images, displays, short messages, and the like are often printed, embossed, or otherwise applied to transparent, translucent, or opaque sheets for display or as gifts. Examples of such articles are birthday and holiday cards and the like. In some instances, patterns or designs are imprinted upon translucent or transparent panels and assembled to resemble a butterfly, dragonfly, or perhaps a representation of a bird having translucent wings. Some of these devices include complete patterns on each panel, e.g., a word phrase, etc., on one panel and a scenic background on the other panel, with each panel displaying a coherent message or scene on its own and with the images embellishing one another (e.g., foreground and background) when the two translucent sheets are assembled.

The concept of fragmenting a message has also been used to preserve secrecy in a message, by breaking up the message onto two separate sheets with at least one sheet being translucent. The sheets are transmitted and stored in separate locations, allowing the message to be read and understood only when the two sheets are finally brought together. The message fragments are always applied to like surfaces of the sheets, e.g., the upper surface when the sheets are laid flat upon a table or desk.

However, none of these devices or systems describes a display having a plurality of integral leaves with an image, either graphic or literal, fragmented so that the content of the graphic image or literal message cannot be discerned until the leaves are folded into registry. Thus, a display formed of multiple fragmented images solving the aforementioned problems is desired.

### SUMMARY OF THE INVENTION

The display formed of multiple fragmented images comprises two or more image, message, or display fragments applied to a like number of sheets or leaves. A base sheet may be transparent, translucent, or opaque, but all other sheets must be transparent or translucent in order to view the message fragment on the base sheet through the other sheets. Each sheet contains a fragment of the message, image, or display applied to one surface thereof. When the sheets are overlaid in registry, the message fragments are also aligned in registry to allow the image, whether graphical or literal, to be viewed or read as a complete, comprehensive display.

The fragmented display is formed by folding at least one sheet along a fold line, and applying a first image fragment to a first surface of the sheet on one side of the fold line. The remaining message fragment is then applied as a mirror image to the same surface of the sheet on the opposite side of the fold line. When the two portions are folded together to overlie one another, the image fragments are placed in registry to enable them to be viewed and comprehended as a whole. Alternatively, the second portion of the image may be applied in direct orientation to the surface opposite that having the first image portion. The end result is essentially the same as when the two image fragments are applied in mutual mirror image to the same surface of the sheet, i.e., the two fragments combine to form a comprehensible image, display, or message when the two portions of the sheet are folded together to overlie one another.

The fragmented image display is adaptable to more than two sheets, as desired. The sheets may be assembled to form wing panels or similar structures for models or caricatures of butterflies, birds, and/or other flying creatures, either actual or mythical, or booklets or other multiple leaf structures as desired. Attachment means, e.g., magnets, hooks, etc., may be provided to permit the devices to be attached to other structures and used as display ornaments, if so desired.

These and other features of the present invention will become readily apparent upon further review of the following specification and drawings.

### BRIEF DESCRIPTION OF THE DRAWINGS

FIG. 1A is a top left side perspective view of a display formed of multiple fragmented images according to the present invention in the form of a butterfly, shown with the wings separated to show the fragmented display on each wing.

FIG. 1B is a left side elevation view of the butterfly display of FIG. 1A with the wings folded together, showing the complete display visible through the translucent wing panels.

FIG. 2A is a front right side perspective view of a display formed of multiple fragmented images according to the present invention in the form of a fairy doll, shown with wings spread to show the fragmented display on each wing.

FIG. 2B is a right side elevation view of the fairy doll display of FIG. 2A with the wings folded together, showing the complete display visible through the translucent wing panels.

FIG. 3A is a right side perspective view of a display formed of multiple fragmented images according to the present invention in the form of a bird having a translucent body and wings, shown with the wings spread to show the fragmented message on the wings and body.

FIG. 3B is a right side elevation view of the bird display of FIG. 3A with the wings folded to show the complete display visible through the translucent wing panels and body.

FIG. 4A is a perspective view of a display formed of multiple fragmented images according to the present invention in the form of a multiple leaf booklet, shown with the translucent leaves spread to show the fragmented display thereon.

FIG. 4B is an elevation view of the multiple leaf booklet of FIG. 4A with the leaves closed to show the complete display therethrough.

FIG. 5 is a flow chart describing the steps in the formation of a display formed of multiple fragmented images according to the present invention.

Similar reference characters denote corresponding features consistently throughout the attached drawings.

### DETAILED DESCRIPTION OF THE PREFERRED EMBODIMENTS

The present invention comprises a series of embodiments of displays formed of multiple fragmented images in which the displays are formed of a series of transparent or translucent sheets or leaves, with each leaf having a fragmented portion of the image thereon. When the sheets or leaves are folded together to overlay one another, the fragmented images are superimposed in registry with one another to provide a coherent message, image, scene, etc. As used herein, the term “multiple fragmented images” means an image including at least one graphic image or one group of literals forming a word that is fragmented in such a manner that the graphic image or the word is in multiple, or at least two, fragments that must be aligned in registry to discern the graphic image or word.

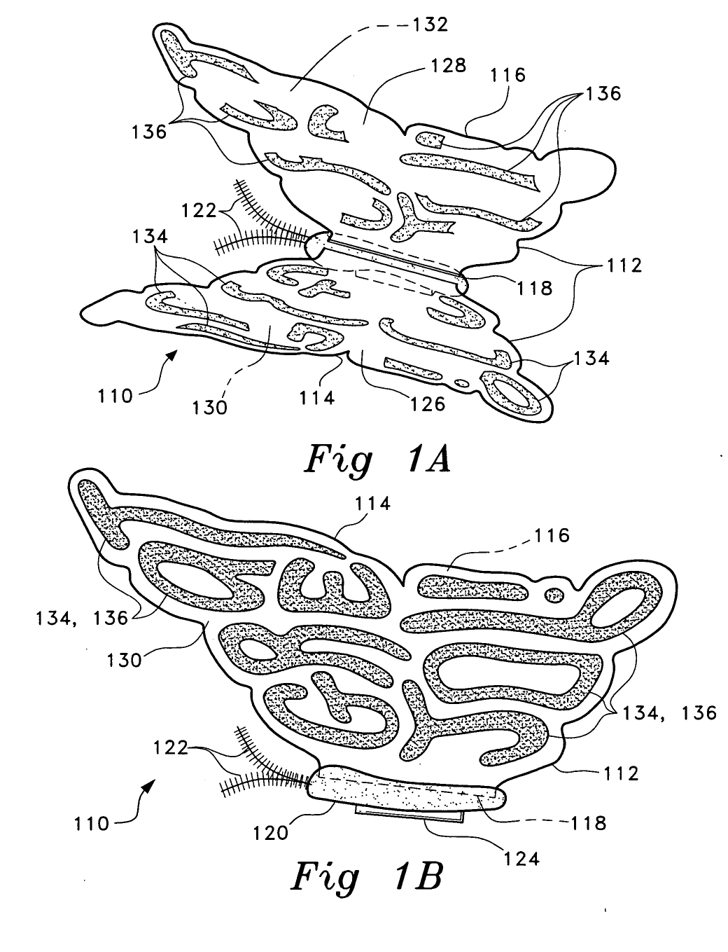

FIGS. 1A and 1B of the drawings illustrate a first embodiment of the present invention, in which a display 110 has a butterfly configuration. The display 110 may be formed of a single, continuous translucent sheet 112 having a first or left leaf 114 and an opposite second or right leaf 116 separated by a fold line 118 extending thereacross. Alternatively, the sheet 112 may be formed of two separate components joined along their mutual edges.

In the case of the display 110, the fold line (or two panel mutual edge) is crimped or captured within a synthetic body 120 resembling the body of a butterfly, in keeping with the butterfly wing shapes of the two leaves 114 and 116 of the translucent sheet 112. The butterfly effect may be enhanced further by providing simulated antennae 122 extending from the forward end of the body 120. A magnet 124, or other temporary and removable attachment means, e.g., a hook, light adhesive, one component of mating hook and loop fabric material (e.g., Velcro®), etc., may be provided to attach the display 110 to another object as desired.

The first and second leaves 114 and 116 of the translucent sheet 112 each include a first surface, respectively 126 and 128, and an opposite second surface, respectively 130 and 132. The two first surfaces 126, 128 face upwardly when the butterfly display 110 is arranged with its wing panels or leaves 114 and 116 spread, as shown in FIG. 1A, with the two second surfaces 130, 132 facing downwardly when the wing panels 114, 116 are spread. That is, the two first surfaces 126, 128 form a continuous surface across the wing sheet 112 before it is folded along the fold line 118, with the two second surfaces 130, 132 forming a second continuous surface on the opposite side or surface of the sheet 112.

The two first surfaces 126, 128, i.e., the upper surfaces in FIG. 1A, each include a fragmented image applied thereto, e.g., printed, embossed, painted, etched, etc. The means of applying the image to the panels or portions 114 and 116 is not critical to the present invention. In the case of the example of FIGS. 1A and 1B, a first fragmented image portion 134 is applied to the first or upper surface 126 of the first wing panel or leaf 114, with a second fragmented image portion 136 being applied to the first or upper surface 128 of the second wing or leaf 116. The fragmented image portions 136 and 138 may comprise fragments of letters of a written message, e.g., “Great Job!,” as indicated by the combined fragments 134, 136 visible through the folded together translucent panels 114 and 116 in FIG. 1B, or other message, scene, display, etc. as desired.

It will be noted that the two fragmented image portions 134 and 136 are in registry with one another and legible or comprehensible when the two wing portions 114 and 116 are folded together, as shown in FIG. 1B. When the two fragmented image portions 134 and 136 are applied to the first surfaces 126, 128 of the two leaves 114 and 116, one of the two image portions is applied as a mirror image to the other image portion. In the example of FIGS. 1A and 1B, the first fragmented image portion 134 is applied as a mirror image to the first surface 126 of the first leaf 114 so that the image appears in correct orientation when viewed with the second surface 138 facing the viewer. The second fragmented image portion 136 is applied in direct orientation, i.e., legible on an opaque surface if formed as a complete image, to the first surface 128 of the second panel or leaf 116. When the two wing panel portions 114 and 116 are folded together with their first surfaces immediately adjacent to and facing one another, this mirror imaging of the two message fragments 134, 136 relative to one another permits the two fragments 134, 136 to align in registry with one another to permit the image to be read and/or comprehended properly.

This process of applying one of the fragmented images in mirror image to the same surface of the sheet 112 as the opposite fragmented image permits the application (printing, silk screening, etc.) of the two image fragments upon the unfolded leaf or sheet 112 without need to reverse or turn over the sheet to apply a portion of the image to its opposite side or surface. It will be seen that the second image fragment 136 could be applied in mirror image to the first surface 128 of the second panel or leaf 116, and the first image fragment 134 applied in direct or proper orientation to the first surface 126 of the first panel or leaf 114, if so desired, since both leaves 114 and 116 are translucent. In this case, the entire image would appear as a mirror image in the orientation shown in FIG. 1B, with the display 110 being required to be turned around to face to the right side in FIG. 1B for proper viewing of the image. Similarly, the image fragments could both be applied to the second surfaces 130 and 132 of the two panels 114 and 116, with one of the image fragments being applied in mirror image to the other fragment, if so desired.

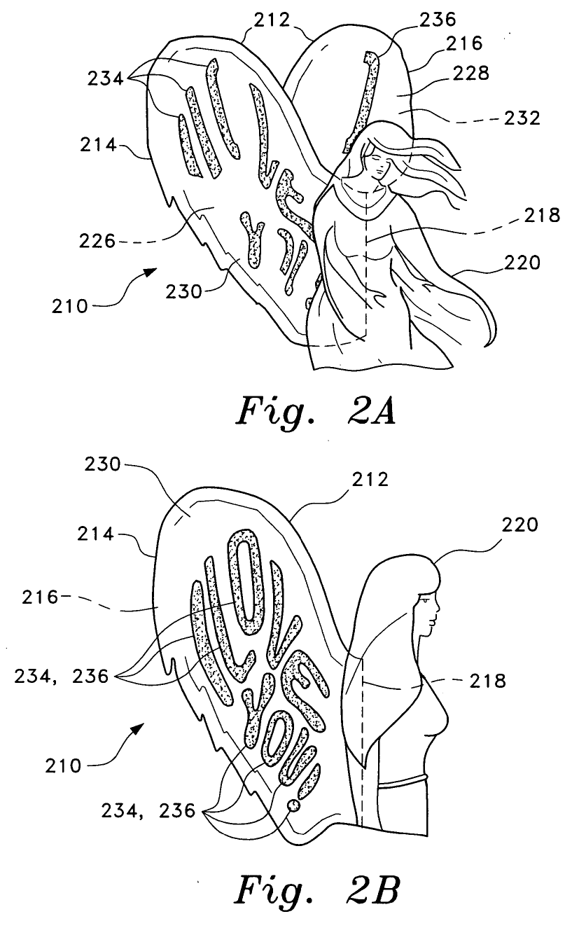

FIGS. 2A and 2B of the drawings illustrate a second embodiment of the present display, depicting an angel or fairy display 210. The angel or fairy display 210 is generally similar to the butterfly embodiment 110 of FIGS. 1A and 1B, having a transparent or translucent sheet 212 divided into two leaves or panels 214 and 216 separated by a fold line 218. As in the case of the butterfly embodiment 110 of FIGS. 1A and 1B, the two panels 214 and 216 may comprise separate sheets joined together along their mutual edges, if so desired.

The fold line (or two panel mutual edge) is crimped or captured within a synthetic body 220 resembling an angel or fairy, in keeping with the wing shapes of the two panels 214 and 216 of the translucent sheet 212. A magnet, not shown in FIGS. 2A and 2B but similar to the magnet 124 of the butterfly embodiment of FIGS. 1A and 1B, or other temporary and removable attachment means, e.g., a hook, light adhesive, one component of mating hook and loop fabric material (e.g., Velcro®), etc., may be provided to attach the display 210 to another object as desired.

The first and second leaves or panels 214 and 216 of the translucent sheet 212 each include a first surface, respectively 226 and 228, and an opposite second surface, respectively 230 and 232. The two first surfaces 226, 228 face one another when they are folded toward one another along the fold line 218 as shown in FIG. 2A of the drawings, with the two second surfaces 230, 232 facing away from one another when the wing panels 214, 216 are partially spread. That is, the two first surfaces 226, 228 form a continuous surface across the wing sheet 212 before it is folded along the fold line 218, with the two second surfaces 230, 232 forming a second continuous surface on the opposite side or surface of the sheet 212.

The embodiment of FIGS. 2A and 2B illustrates another means of applying the images to the translucent leaf portions 214 and 216 than that described for the embodiment 110 of FIGS. 1A and 1B. In the embodiment 210 of FIGS. 2A and 2B, the first fragmented image 234 is applied (e.g., printed, embossed, painted, etched, etc.; the specific means is not critical) in direct or proper orientation to the second surface 230 of the first wing panel or leaf 214, with a second fragmented image portion 236 being applied in direct or proper orientation to the first or upper surface 228 of the second wing or leaf 216. The fragmented image portions 236 and 238 may comprise fragments of letters of a written message, e.g., “I Love You!,” as indicated by the combined fragments 234, 236 visible through the folded together translucent panels 214 and 216 in FIG. 2B, or other message, scene, display, etc. as desired.

The application of the two message fragments 234 and 236 to opposite surfaces of the two panels 214 and 216 permits both message fragments to be applied in direct or proper orientation, i.e., no mirror imaging of either message portion 214 or 216 is performed in order for the two message portions 214 and 216 to appear as a complete and comprehensible message, as shown in FIG. 2B. However, the two fragmented image portions 234 and 236 could both be applied to the first surfaces 226 and 228 of the two panels or leaves 214, 216 of the embodiment 210, if so desired. This can be done by applying one of the two image fragments in mirror image relative to the other, just as in the case of the embodiment 110 of FIGS. 1A and 1B. For the complete image to be read properly as in the orientation shown in the right side elevation view of FIG. 2B, the first image portion or fragment 234 is applied in mirror image to the first surface 216 of the first panel or leaf 214, with the opposite second image fragment 236 being applied in proper or direct orientation to the second surface 232 of the second panel or leaf 216. Alternatively, the first image fragment 234 could be applied in direct or proper orientation to the second surface 230 of the first panel 214, with the opposite second image fragment 236 being applied in mirror image to the corresponding second surface 232 of the second panel 216. The specific panel surfaces to which the image fragments are applied are not critical to the present invention, so long as the image fragments are both viewable in their proper orientations when the two panels 214 and 216 are folded together in registry with one another, as shown in the example of FIG. 2B.

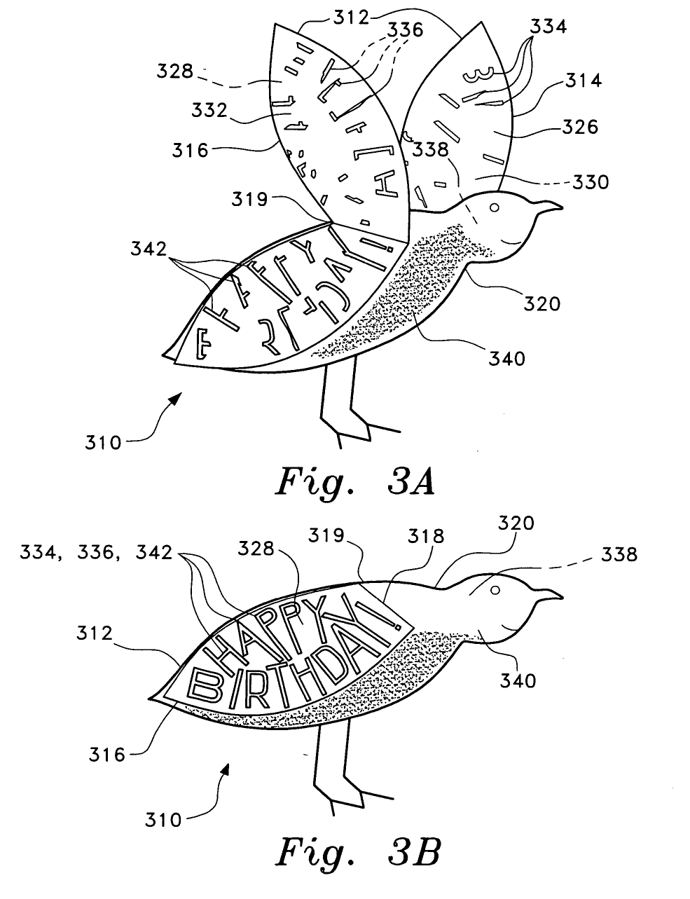

FIGS. 3A and 3B illustrate yet another embodiment 310, in which the device resembles a bird or similar creature. As in the cases of the embodiments 110 and 210 of FIGS. 1A through 2B, the specific configuration of the embodiment is not critical to the concept of the invention, but is merely illustrative of another configuration which may be used to carry out another aspect of the invention. In FIGS. 3A and 3B, the display 310 is formed of a single, continuous translucent sheet 312 having a first or left leaf 314 and an opposite second or right leaf 316 separated by a fold line 318 extending thereacross.

Alternatively, the sheet 312 may be formed of two separate components joined along their mutual edges or secured (e.g., by adhesive means, etc.) to a third translucent panel or leaf 320 disposed therebetween. In the case of the display 310, the fold line 318 or two panel mutual edge) is captured within a slot 319 formed through a thin, translucent synthetic body third panel or leaf 320 resembling the outline or profile of a bird. A magnet, not shown in FIGS. 3A and 3B but similar to the magnet 124 of the butterfly embodiment of FIGS. 1A and 1B, or other temporary and removable attachment means, e.g., a hook, light adhesive, one component of mating hook and loop fabric material (e.g., Velcro®), etc., may be provided to attach the display 310 to another object as desired.

The first and second leaves 314 and 316 of the translucent sheet 312 each include a first surface, respectively 326 and 328, and an opposite second surface, respectively 330 and 332. The two first surfaces 326, 328 face upwardly when the bird display 310 is arranged with its wing panels or leaves 314 and 316 spread, as shown in FIG. 3A, with the two second surfaces 330, 332 facing downwardly when the wing panels 314, 316 are spread. That is, the two first surfaces 326, 328 form a continuous surface across the wing sheet 312 before it is folded along the fold line 318, with the two second surfaces 330, 332 forming a second continuous surface on the opposite side or surface of the sheet 312.

The two first surfaces 326, 328, i.e., the upper surfaces in FIG. 3A, each include a fragmented image applied thereto, e.g., printed, embossed, painted, etched, etc. The means of applying the image to the panels or leaves 314 and 316 is not critical to the present invention. In the case of the example of FIGS. 3A and 3B, a first fragmented image portion 334 is applied to the first or upper surface 326 of the first wing panel or leaf 314, with a second fragmented image portion 336 being applied to the first or upper surface 328 of the second wing or leaf 316. The fragmented image portions 336 and 338 may comprise fragments of letters of a written message, e.g., “Happy Birthday!,” as indicated by the completed message visible through the folded together translucent panels 314, 316, and 320 in FIG. 3B, or other message, scene, display, etc. as desired.

In addition to the two image fragments 334 and 336, the translucent body portion or leaf 320 also includes a third set of image fragments thereon. The translucent body 320 includes a first surface 338 and an opposite second surface 340, with a third fragmented image portion 342 being applied to either surface 338 or 340 as desired. In the example of FIGS. 3A and 3B, the first and second fragmented image portions 334 and 336 are shown applied to the upper or first surfaces 326 and 328 of the two translucent wing panels 314 and 316, with the first fragmented image portion 334 being applied as a mirror image. The third image portion 342 is shown applied to the second or right side surface 340 of the translucent body 320, in direct or proper orientation.

In this manner, as the first or left wing panel or leaf 314 folds with its first surface 326 facing outwardly, the first fragmented image portion 334 may be viewed in proper orientation from the opposite, right side of the assembly 310. The second fragmented image portion 336 is viewed in proper orientation from the right side of the assembly when the second or right wing panel or leaf 316 is folded downwardly and back against the body panel 320, generally as shown in FIG. 3B. The third fragmented image portion 342 is also viewed in proper orientation when it has been applied to the second or right surface 340 of the translucent body panel 320. The result is a legible, comprehensible message, image, or display formed of the fragmented components 334, 336, and 342 when the two wing panels or leaves 314 and 316 are folded back over the body panel or leaf 320 to lie in registry therewith, generally as shown in FIG. 3B of the drawings. It will be seen that the application of any of the message fragments to surfaces opposite those described above would necessitate their opposite image fragments (either direct or mirror) being used. Similarly, the image fragments described must be reversed (either mirror or direct) if the completed image is to be viewed from the left side of the device 310.

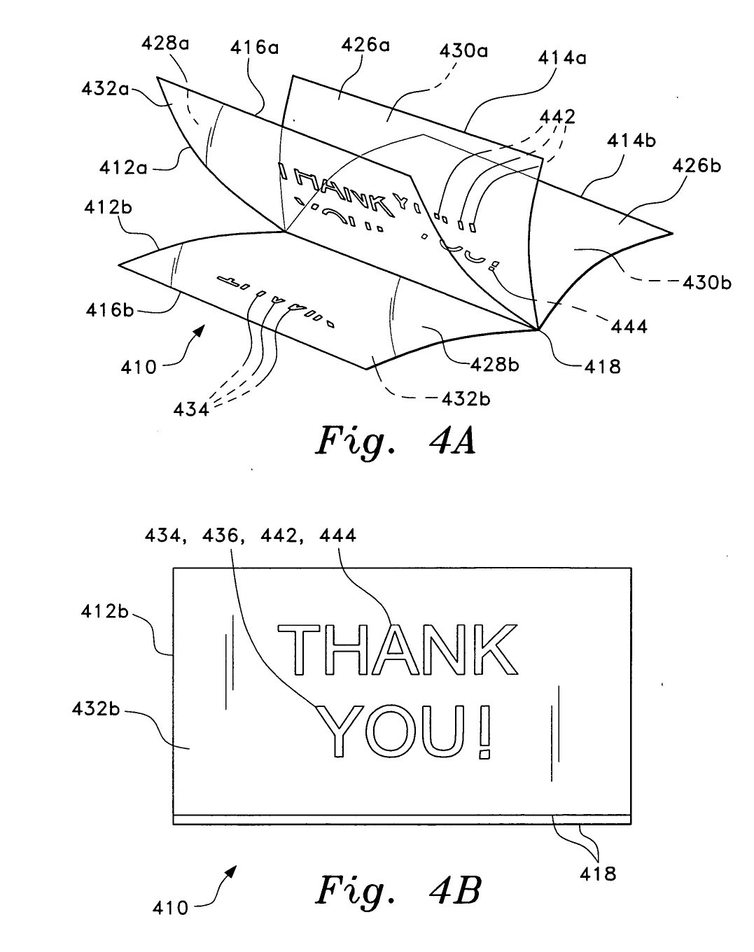

FIGS. 4A and 4B illustrate still another embodiment of the present invention, in which multiple translucent leaves are combined to form a booklet 410 or the like with each leaf having a fragment of an image, message, or display thereon. In FIGS. 4A and 4B, two separate translucent sheets 412a and 412b are used to form the booklet assembly 410, although it will be seen that additional translucent sheets may be added to the two sheets 412a and 412b if so desired.

Each sheet 412a and 412b includes a first or right leaf, respectively 414a and 414b, and an opposite second or left leaf, respectively 416a and 416b, separated by a fold line 418 extending thereacross. Alternatively, the sheets 412a, 412b may each be formed of two separate components joined along their mutual edges. In the case of the display 410, the sheets 412a, 412b, etc., are bound together (e.g., stapled, adhesively secured, etc.) along the fold or binding line 418 to form a spine for the booklet 410. A magnet (not shown) or other temporary and removable attachment means as described further above, may be provided along the spine or across the back of the rearmost sheet or panel to attach the display 410 to another object as desired.

Each of the leaves 414a and 416a includes a first surface 426a and 428a, respectively, and an opposite second surface 430a and 432a, respectively. Similarly, each leaf 414b, 416b includes a first surface 426b and 428b, respectively, and an opposite second surface 430b and 432b, respectively. As the various leaves are folded over to form a closed booklet when folded about the fold line 418, it will be seen that the first surfaces 428a and 428b of the second leaves 416a and 416b face upwardly when closed, while the second surfaces 430a, 430b of the first leaves 414a, 414b face upwardly when folded along the fold or binding line 418.

Accordingly, first and second fragmented image portions 434 and 436 may be respectively applied as mirror images to the first surfaces 428b and 428a of the second leaves 416b and 416a. Similarly, complementary third and fourth fragmented images 442 and 444 may be applied in direct orientation to the second surfaces 430b, 430a of the first leaves 414b, 414a. When the booklet 410 is folded closed with its fold or binding line 418 oriented downwardly, as shown in FIG. 4B, the various fragmented message portions 434, 436, 442, and 444 all align in registry to allow the complete image to be viewed through the translucent sheets.

It will be seen that the above described image portions may be applied in opposite image, i.e., mirror image, rather than proper or direct, and direct rather than mirror, when the image portions are applied to the opposite surfaces of the sheets than as described above. Also, it should be noted that as the first leaf 414b of the second sheet 412b forms the back sheet portion for the assembly when folded closed as shown in FIG. 4B, that leaf 414b may be formed of an opaque sheet if desired, so long as its image portion is applied to the first surface 426b thereof in a direct or proper orientation. Additional leaves or sheets may be added to the exemplary embodiment of FIGS. 4A and 4B as desired, generally as described above.

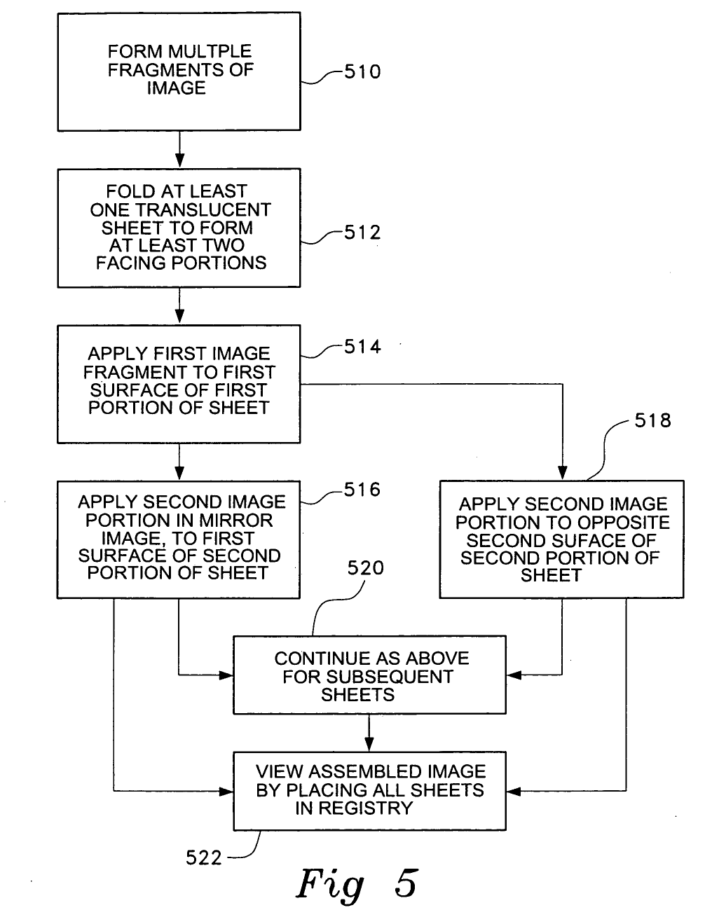

FIG. 5 provides a flow chart illustrating the general steps in a method of making a display formed of present multiple fragmented images according to the present invention. Initially, the desired image (word message, scene, pattern, etc., as desired) is broken up into a series of fragmented portions, generally as indicated by the first step 510 of FIG. 5. This may be done by means of a suitable computer program, by hand, or in some other manner as desired. At least one sheet of translucent (or transparent) material is then folded along a fold line to form two leaves defined by the fold line having facing portions, generally as indicated by the second step 512 of FIG. 5.

At this point, a first portion of the fragmented image is applied to the first surface of the first facing portion of the sheet, in proper or direct orientation of the image. This is indicated generally by the third step 514 of FIG. 5. The second image portion is then applied in mirror image to the same surface, i.e., the first surface, of the sheet, but on the second facing portion of the sheet across the fold line from the first portion. This is indicated generally by the fourth step 516 of FIG. 5. The application of these two image portions may be accomplished simultaneously when printed or otherwise applied to the same surface, e.g., the first surface, of the sheet.

It is possible to avoid reversing at least one of the image fragments to form a mirror image, so long as the non-reversed image fragment(s) is/are applied to the opposite surfaces of the sheet from those images applied to the first leaf. In other words, first and second image portions both applied to the first surface of a sheet must have one of the image portions in mirror image to the other. However, first and second image portions applied to opposite surfaces of the sheet on opposite sides of the fold line need not include reversal of one of the images relative to the other. However, this entails an additional step of turning the sheet over to apply the image to the opposite surface thereof. If this procedure is desired, it is indicated by the optional fifth step 518 of FIG. 5.

The images may be applied by a printing process, silk-screening, conventional dry toner copying process, etc., as desired. For limited editions of the device, rub-on lettering or sheets could be used, with only portions of the lettering or sheets being applied to each specific surface of the various translucent sheets. Those portions not securely pressed or rubbed into place, pull loose to be applied to other areas of other sheets. The above-described process may be continued by adding additional translucent sheets to the assembly, and fragmenting the image into a number of smaller portions corresponding to the number of surfaces to which the image is to be applied, generally as indicated by the sixth step 520 of FIG. 5.

When the above process has been completed, the various sheets are folded along the fold line to align the leaves (or more properly, the image fragments) in registry with one another. The complete image formed by all of the fragments in registry may then be viewed as a single, comprehensible image through the various translucent sheets, generally as indicated by the final seventh step 522 of FIG. 5.

In conclusion, the display formed of multiple fragmented images provides a means of relaying or sending a message, which provides the recipient with a most intriguing and entertaining means of assembling and comprehending the message or display. Various variations may be provided with the multiple fragmented image displays, including forming the sheet portion that forms the lowermost panel or leaf of the assembly of opaque material. As no further image fragments are positioned below the lowermost leaf, it need not be translucent or transparent so long as the image fragment is applied to the surface visible through the other translucent leaves of the assembly. The translucent leaves may be assembled with other structure to provide an assembly resembling an actual or mythical animal, being, or other article, as desired. The display may be provided with some means of securing the device temporarily to another article (e.g., magnet, hook, hook and loop fabric material, etc.). Yet, the multiple fragmented image display in its various embodiments is relatively inexpensive to produce, and will find great utility in the form of party favors, guest place markers at various dinner and other events, and similar activities, in addition to use in lieu of conventional holiday, birthday, and other cards for various occasions.

It is to be understood that the present invention is not limited to the embodiments described above, but encompasses any and all embodiments within the scope of the following claims.

1. A display formed of multiple fragmented images, comprising:
a single, continuous translucent sheet having a first leaf, a second leaf separated from the first leaf by a fold line, a first surface, and a second surface opposite the first surface;
a first fragmented image pattern disposed upon the first leaf;
a second fragmented image pattern disposed upon the second leaf, said second fragmented image pattern being complementary to said first fragmented image pattern so that said first fragmented image pattern and said second fragmented image pattern form a complete and comprehensible image in registry with one another when the first leaf and the second leaf are folded together along the fold line; and
a body structure disposed along the fold line of said translucent sheet, so that said translucent leaf and said body structure resemble an actual or mythical animal or being.

2. The display according to claim 1, wherein:
said first fragmented image pattern is disposed upon the first surface of the first leaf; and
said second fragmented image pattern is disposed upon the first surface of the second leaf in mirror image relative to said first fragmented image pattern.

3. The display according to claim 1, wherein:
said first fragmented image pattern is disposed upon the first surface of the first leaf; and
said second fragmented image pattern is disposed upon the second surface of the second leaf in a direct image relative to said first fragmented image pattern.

4. The display according to claim 1, further including:
at least one additional leaf attached to said translucent sheet; and
at least one additional fragmented image pattern disposed upon said at least one additional leaf, so that said at least one additional fragmented image pattern forms a complete and comprehensible image in registry with said first fragmented image pattern and said second fragmented image pattern when the first leaf and the second leaf and the at least one additional leaf are folded together.

5. The display according to claim 4, wherein said at least one additional leaf comprises a single opaque base sheet underlying the first leaf and the second leaf when the first leaf and the second leaf and said at least one additional leaf are folded together.

6. (canceled)

7. The display according to claim 1 further including means for removably attaching said translucent sheet to another object.

8. A display formed of multiple fragmented images, comprising:
a plurality of continuous translucent sheets, each of the sheets having a first leaf, a second leaf separated from the first leaf by a fold line, a first surface, and a second surface opposite the first surface, each of said translucent sheets being joined to one another along their fold lines;
a single fragmented image pattern disposed upon the first leaf of each of said translucent sheets;
a single fragmented image pattern disposed upon the second leaf of each of said translucent sheets, each said fragmented image pattern being complementary to every other said fragmented image pattern so that all said fragmented image patterns form a complete and comprehensible image in registry with one another when the first leaf and the second leaf of each said translucent sheet are folded together along their fold lines; and
a body structure disposed along the fold lines of said translucent sheets so that said translucent leaves and said body structure resemble an actual or mythical animal or being.

9. The display according to claim 8, wherein:
at least one said fragmented image pattern is disposed upon the first surface of the first leaf; and
at least one other said fragmented image pattern is disposed upon the first surface of the second leaf of at least one other said translucent sheet in mirror image relative to said at least one fragmented image pattern.

10. The display according to claim 8, wherein:
at least one said fragmented image pattern is disposed upon the first surface of the first leaf; and
at least one other said fragmented image pattern is disposed upon the second surface of the second leaf in a direct image relative to said at least one fragmented image pattern.

11. The display according to claim 8, further including a single opaque base leaf underlying the first leaf and the second leaf of each of said translucent sheets when the first and the second leaves and said base leaf are folded together.

12. (canceled)

13. The display according to claim 8, further including means for removably attaching said translucent sheets to another object.

14-20. (canceled)
